(19) United States
(12) Patent Application Publication
(10) Pub. No.: US 2017/0061491 A1
(43) Pub. Date: Mar. 2, 2017

(54) PRODUCT INFORMATION DISPLAY SYSTEM, CONTROL DEVICE, CONTROL METHOD, AND COMPUTER-READABLE RECORDING MEDIUM

(71) Applicant: FUJITSU LIMITED, Kawasaki-shi (JP)

(72) Inventors: Shohei Kuwabara, Itabashi (JP); Fumito Ito, Kita (JP); Sayaka Suwa, Itabashi (JP); Naoki Kaneda, Kawasaki (JP)

(73) Assignee: FUJITSU LIMITED, Kawasaki-shi (JP)

(21) Appl. No.: 15/349,471

(22) Filed: Nov. 11, 2016

Related U.S. Application Data
(63) Continuation of application No. PCT/JP2014/062639, filed on May 12, 2014.

(51) Int. Cl. G06Q 30/02; H04N 5/232; G06K 9/00

(52) U.S. Cl. CPC G06Q 30/0261; G06K 9/00362; H04N 5/23293

(57) ABSTRACT

A product information display system includes: a sensor; a first display; a second display; and a processor. The processor is configured to: perform a first start of displaying, on the first display, first information related to a specific product specified in accordance with an attribute of a person detected by the sensor; and perform a second start of displaying, on the second display, second information related to the specific product when it is detected that a behavior of the detected person indicates a predetermined behavior after the first start of display.

### CROSS-REFERENCE TO RELATED APPLICATION

This application is a continuation application of International Application No. PCT/JP2014/062639, filed on May 12, 2014 and designating the U.S., the entire contents of which are incorporated herein by reference.

### FIELD

The embodiments discussed herein are related to a product information display system, a control device, a control method, and a computer-readable recording medium.

### BACKGROUND

As a technology that provides advertisements having appealing power by using a plurality of displays, there is a technology that outputs, when, for example, a sensor detects a human body, content onto a display that is arranged at the subject location.

Patent Document 1: Japanese Laid-open Patent Publication No. 2004-102714

With the technology described above, for example, when a sensor detects a human body, by outputting an advertisement related to a product onto the display that is arranged at the subject location, it is possible to provide the advertisement related to the product to the person; however, it is not possible to easily and continuously make the person interested in the products.

### SUMMARY

According to an aspect of the embodiments, a product information display system includes: a sensor; a first display; a second display; and a processor configured to: perform a first start of displaying, on the first display, first information related to a specific product specified in accordance with an attribute of a person detected by the sensor; and perform a second start of displaying, on the second display, second information related to the specific product when it is detected that a behavior of the detected person indicates a predetermined behavior after the first start of display.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating an example of a store configuration;

FIG. 2 is a schematic diagram illustrating, in outline, the overall configuration of a product information display system;

FIG. 3 is a schematic diagram illustrating an example of position information on the location of a region of a human body output from a sensor device;

FIG. 4 is a schematic diagram illustrating an example of the functional configuration of a control device;

FIG. 5 is a schematic diagram illustrating an example of the data structure of product information;

FIG. 6 is a schematic diagram illustrating an example of the data structure of display content information;

FIG. 7 is a schematic diagram illustrating an example of the data structure of product impression information;

FIG. 8 is a schematic diagram illustrating an example of an area;

FIG. 9 is a schematic diagram illustrating detection of a pickup;

FIG. 10 is a schematic diagram illustrating an example of an image displayed on a display;

FIG. 11 is a schematic diagram illustrating an example of an image displayed on a tablet terminal;

FIG. 12 is a schematic diagram illustrating an example of images projected;

FIG. 13 is a flowchart illustrating an example of the flow of a display control process; and

FIG. 14 is a block diagram illustrating a computer that executes a control program.

### DESCRIPTION OF EMBODIMENTS

Preferred embodiments will be explained with reference to accompanying drawings. The present invention is not limited to the embodiments. Furthermore, the embodiments can be used in any appropriate combination as long as the processes do not conflict with each other.

### [a] First Embodiment

### Store Configuration

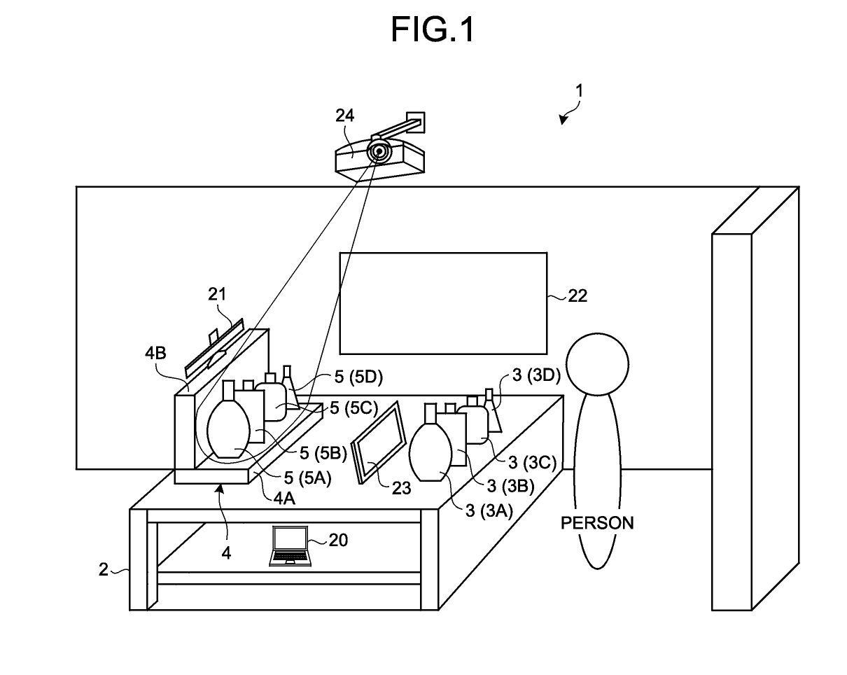

First, an example of the configuration of a store that performs the promotion of products by using a product information display system according to a first embodiment will be described. FIG. 1 is a schematic diagram illustrating an example of a store configuration. As illustrated in FIG. 1, a product shelf 2 on which products are exhibited is provided in a store 1. The product shelf 2 has a top surface with a flat shape, is arranged on the side of an aisle through which a person can pass, and on which products are exhibited along the aisle. In the embodiment, a case in which products are perfumes 3 are used as an example and four types of perfumes 3A to 3D are exhibited as the products on the product shelf 2. Furthermore, the products are not limited to perfumes and, furthermore, the number of types is not limited to four.

Furthermore, on the product shelf 2, a tablet terminal 23 is arranged on the farther side of the perfumes 3A to 3D seen from the aisle such that the display screen is arranged in the direction of the aisle. Furthermore, on the product shelf 2, a display stand 4 that is used to display the products is arranged on the farther side of the tablet terminal 23 seen from the aisle. The display stand 4 is formed from a stand portion 4A and a wall portion 4B with the structure of an L shape in cross section and is constructed such that one side of the flat shaped board on the farther side is bent upwardly. On the stand portion 4A, perfumes 5 that have the same number of types as those of the perfumes 3 arranged on the product shelf 2 and that are physically separated from the perfumes 3 are arranged. In the embodiment, perfumes 5A to 5D that have the same number of types, i.e., four types, as those of the perfumes 3A to 3D and that are physically separated from the perfumes 3A to 3D are arranged in the same arrangement order as that of the perfumes 3A to 3D in an associated manner with the perfumes 3A to 3D, respectively. The perfumes 5 may also be the same perfumes 3 or may also be dummies that can be seem strikingly similar to the real thing in appearance. Furthermore, on the wall portion 4B, a sensor device 21 is provided. The sensor device 21 can detect a person and is arranged such that the aisle side is a detection area. Furthermore, a control device 20 is arranged inside the product shelf 2.

Furthermore, a projector 24 is provided in the store 1. The projector 24 is arranged such that the perfumes 5A to 5D can be covered inside a projection area in which a video image can be projected and projection of a video image can be performed with respect to the perfumes 5A to 5D. The projector 24 may also be fixed on a ceiling in the store 1 or fixed on a wall.

Furthermore, a display 22 is provided on the surface of the wall surrounding the store 1. The size of the display screen of the display 22 is greater than that of the tablet terminal 23 such that the display 22 can be seen from a wide range of the position in the store 1 and the display 22 is arranged away from the perfumes 3A to 3D and farther from the position of the tablet terminal 23. Furthermore, the tablet terminal 23 is arranged close to the perfumes 3A to 3D such that a customer can view the display screen when the customer is located in front of the perfumes 3A to 3D.

System Configuration

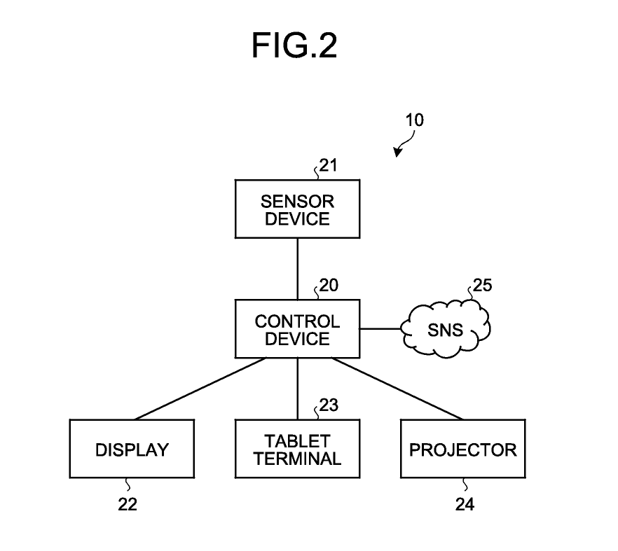

In the following, a product information display system according to the embodiment will be described. FIG. 2 is a schematic diagram illustrating, in outline, the overall configuration of a product information display system. As illustrated in FIG. 2, a product information display system 10 includes the control device 20, the sensor device 21, the display 22, the tablet terminal 23, and the projector 24.

The sensor device 21 is a sensor device that can detect a person. For example, the sensor device 21 has a built-in camera, captures an image at a predetermined frame rate by using the camera, and detects a human body from the captured image. When a human body is detected, the sensor device 21 specifies the position of the region of a human body, such as a head, a fingertip, or the like, by performing a skeletal analysis. Then, the sensor device 21 outputs image data on the captured image and position information indicating the position for each region of the human body. An example of the sensor device 21 includes, for example, KINECT (registered trademark).

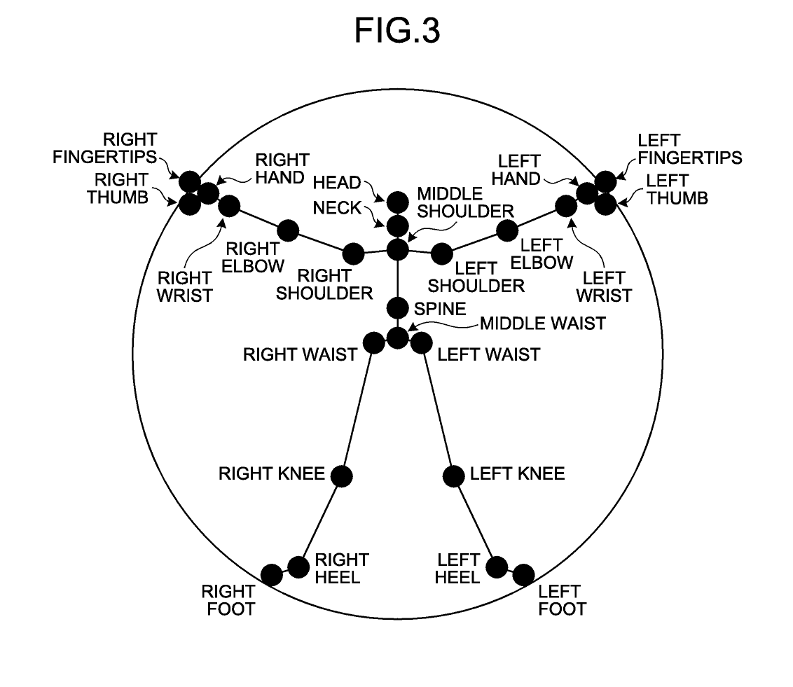

FIG. 3 is a schematic diagram illustrating an example of position information on the location of a region of a human body output from the sensor device. In the example illustrated in FIG. 3, the position for each region of the human body indicated by the position information is represented by dots and the skeletal regions of the human body are represented by connecting these dots.

A description will be given here by referring back to FIG. 2. The display 22 is a display device that displays various kinds of information. An example of the display 22 includes a display device, such as a liquid crystal display (LCD), a cathode ray tube (CRT), or the like. The display 22 displays various kinds of information. For example, in the embodiment, various kinds of images, such as video images of advertisements, or the like, are displayed on the display 22.

The tablet terminal 23 is a terminal device in which various kinds of information can be displayed and input. In the embodiment, the tablet terminal 23 is used as a display device that performs promotion on individual customer. Instead of the tablet terminal 23, a display or a notebook type personal computer may also be used as this display device.

The projector 24 is a projection device that projects various kinds of information. The projector 24 performs display by projecting various kinds of information. For example, by using the projector 24, a video image that indicates an image representing a subject product is projected in the direction of the product. For example, a video image representing an odor, a taste, a texture, a sound or the like, emitted from the product is projected. In the embodiment, the video image representing the odor of each of the perfumes 5A to 5D is projected in the direction of the perfumes 5A to 5D.

The control device 20 is a device that performs the overall control of the product information display system 10. The control device 20 is, for example, a computer, such as a personal computer, a server computer, or the like. The control device 20 may also be mounted as a single computer or may also be mounted as a plurality of computers. Furthermore, in the embodiment, a case in which the control device 20 is used as a single computer will be described as an example.

The control device 20 is connected to the sensor device 21 and can detect a customer via the sensor device 21. Furthermore, the control device 20 is connected to the display 22, the tablet terminal 23, and the projector 24 and can control a video image to be displayed by controlling the display 22, the tablet terminal 23, and the projector 24. Furthermore, the control device 20 is connected to a SNS (social networking service) 25 via a network (not illustrated) such that control device 20 can perform communication with the SNS 25 and can exchange various kinds of information. Any kind of communication network, such as mobile unit communication for a mobile phone or the like, the Internet, a local area network (LAN), a virtual private network (VPN), or the like, may be used as the network irrespective of whether the network is a wired or wireless connection.

The SNS 25 is a cloud system that provides social media that performs information distribution by users posting and exchanging messages with each other. The SNS 25 may also be mounted on a single computer or may also be mounted on a plurality of computers. An example of the SNS 25 includes, for example, Twitter (registered trademark), Facebook (registered trademark), or the like.

Configuration of the Control Device

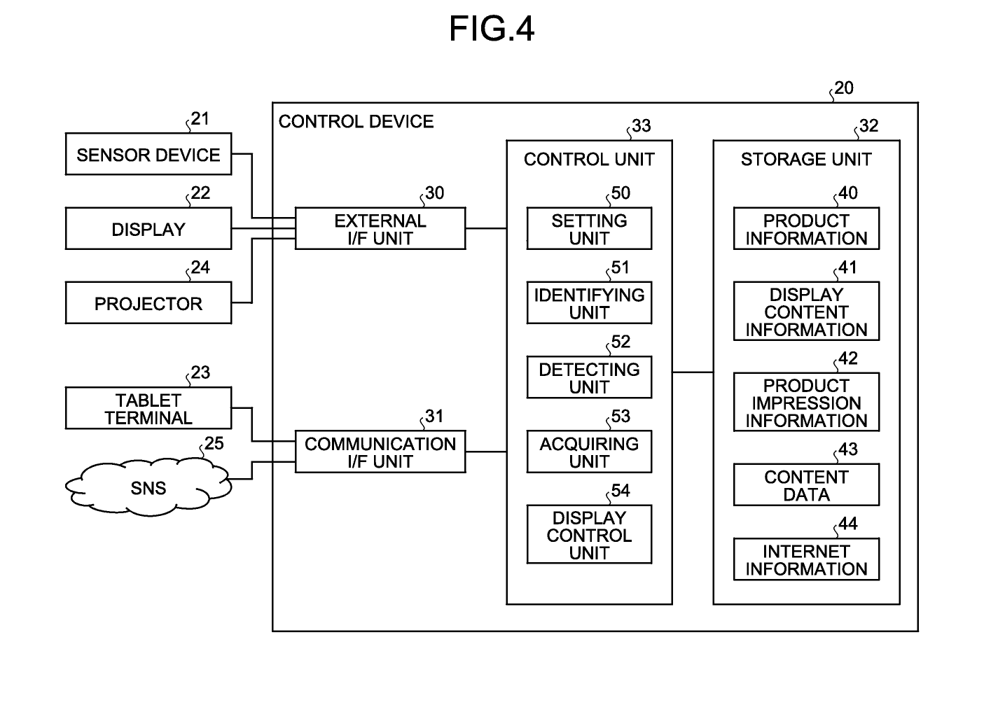

In the following, the configuration of the control device 20 according to the embodiment will be described. FIG. 4 is a schematic diagram illustrating an example of the functional configuration of the control device. As illustrated in FIG. 4, the control device 20 includes an external interface (I/F) unit 30, a communication I/F unit 31, a storage unit 32, and a control unit 33.

The external I/F unit 30 is an interface that inputs and outputs of various kinds of data. The external I/F unit 30 may also be an interface, such as a universal serial bus (USB), or the like. Furthermore, the external I/F unit 30 may also be a video image interface, such as a D-subminiature (D-Sub), a digital visual interface (DVI), a DisplayPort, a high-definition multimedia interface (HDMI) (registered trademark), or the like.

The external I/F unit 30 inputs and outputs various kinds of information from and to other connected devices. For example, the external I/F unit 30 is connected to the sensor device 21 and to which image data on a captured image and position information that indicates the position of the region of a human body is input from the sensor device 21. Furthermore, the external I/F unit 30 is connected to the display 22 and the projector 24 and outputs data on a video image that is displayed on the display 22 and that is projected from the projector 24.

The communication I/F unit 31 is an interface that performs communication control with the other devices. A network interface card, such as a LAN card can be used as the communication I/F unit 31.

The communication I/F unit 31 sends and receives various kinds of information to and from other devices via a network (not illustrated). For example, the communication I/F unit 31 sends data on a video image that is displayed on the tablet terminal 23. Furthermore, the communication I/F unit 31 receives information related to messages posted from the SNS 25.

The storage unit 32 is a storage device that stores therein various kinds of data. For example, the storage unit 32 is a storage device, such as a hard disk, a solid state drive (SSD), an optical disk, or the like. Furthermore, the storage unit 32 may also be a data rewritable semiconductor memory, such as a random access memory (RAM), a flash memory, a nonvolatile static random access memory (NVSRAM), or the like.

The storage unit 32 stores therein an operating system (OS) and various kinds programs executed by the control unit 33. For example, the storage unit 32 stores therein various kinds of programs including the program that executes a display control process that will be described later. Furthermore, the storage unit 32 stores therein various kinds of data used by the program that is executed by the control unit 33. For example, the storage unit 32 stores therein product information 40, display content information 41, product impression information 42, content data 43, and Internet information 44.

The product information 40 is data that stores therein information related to the products targeted for promotion. In the embodiment, information related to the perfumes 3A to 3D is stored in the product information 40. For example, information on the product, such as product name or the like or information on purchasers to be targeted, is stored in the product information 40 for each product.

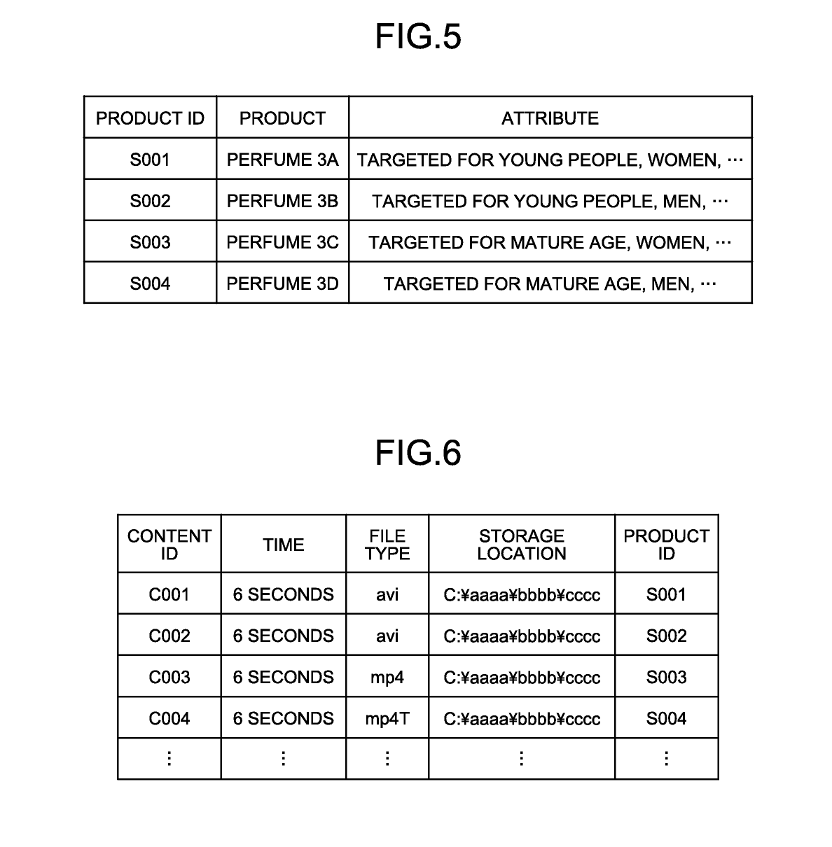

FIG. 5 is a schematic diagram illustrating an example of the data structure of product information. As illustrated in FIG. 5, the product information 40 includes items of the “product ID”, the “product”, and the “attribute”. The item of the product ID is an area that stores therein identification information for identifying the product. A unique product ID is attached to the product as the identification information that is used to identify each of the products. The item of the product ID stores therein the product ID attached to the product. The item of the product is an area that stores therein information indicating the product, such as the product name or the like. The item of the attribute is an area that stores therein information related to purchasers targeted by the products.

In the example illustrated in FIG. 5, product ID “S001” indicates that the product is the “perfume 3A” and the attribute of the target purchasers is “targeted for young people and women”. Furthermore, product ID “S002” indicates that the product is the “perfume 3B” and the attribute of the target purchasers is “targeted for young people and men”. The product ID “S003” indicates that the product is the “perfume 3C” and the attribute of the target purchasers is “targeted for mature age and women”. The product ID “S004” indicates that the product is the “perfume 3D” and the attribute of the target purchasers is “targeted for mature age and men”.

A description will be given here by referring back to FIG. 4. The display content information 41 is data that stores therein information related to the content. For example, the display content information 41 stores therein the type of data on the content and the location in which the content is stored.

FIG. 6 is a schematic diagram illustrating an example of the data structure of display content information. As illustrated in FIG. 6, the display content information 41 includes items of the “content ID”, the “time”, the “file type”, the “storage location”, and the “product ID”. The item of the content ID is an area that stores therein identification information for identifying the content. A unique content ID is attached to the content as the identification information that is used to identify each of the pieces of the content. The content ID attached to the content is stored in the item of the content ID. The item of the time is an area that stores therein playback time of a video image that is saved as the content. The item of the file type is an area that stores therein the type of the data on the content. The item of the storage location is an area that stores therein the storage destination of the data on the content and the file name of the data on the content. In the embodiment, a path to the data on the content is stored in the storage location. The item of the product ID is an area that stores therein identification information for identifying the product.

In the example illustrated in FIG. 6, content ID “C001” indicates that the playback time is “6 seconds”, the file type is “avi”, the storage location is “C:\aaaa\bbbb\cccc”, and the product ID of the associated product is “S001”. The file type “avi” indicates an audio video interleaving (avi) file. The content ID “C002” indicates that the playback time is “6 seconds”, the file type is “avi”, the storage location is “C:\aaaa\bbbb\cccc”, and the product ID of the associated product is “S002”. The content ID “C003” indicates that the playback time is “6 seconds”, the file type is “mp4”, the storage location is “C:\aaaa\bbbb\cccc”, and the product ID of the associated product is “S003”. The file type “MP4” indicates the Moving Picture Experts Group phase 4 (MPEG-4). The content ID “C004” indicates that the playback time is “6 seconds”, the file type is “mp4T”, the storage location is “C:\aaaa\bbbb\cccc”, and the product ID of the associated product is “S004”. The file type “MP4T” indicates MPEG-4 Transport Stream.

A description will be given here by referring back to FIG. 4. The product impression information 42 is data that stores therein information related to an image of the product. For example, the product impression information 42 stores therein information related to images representing the odor, the taste, the texture, the produced sound, or the like emitted from the product. In the embodiment, information related to the image representing the odor emitted from the perfumes 5A to 5D.

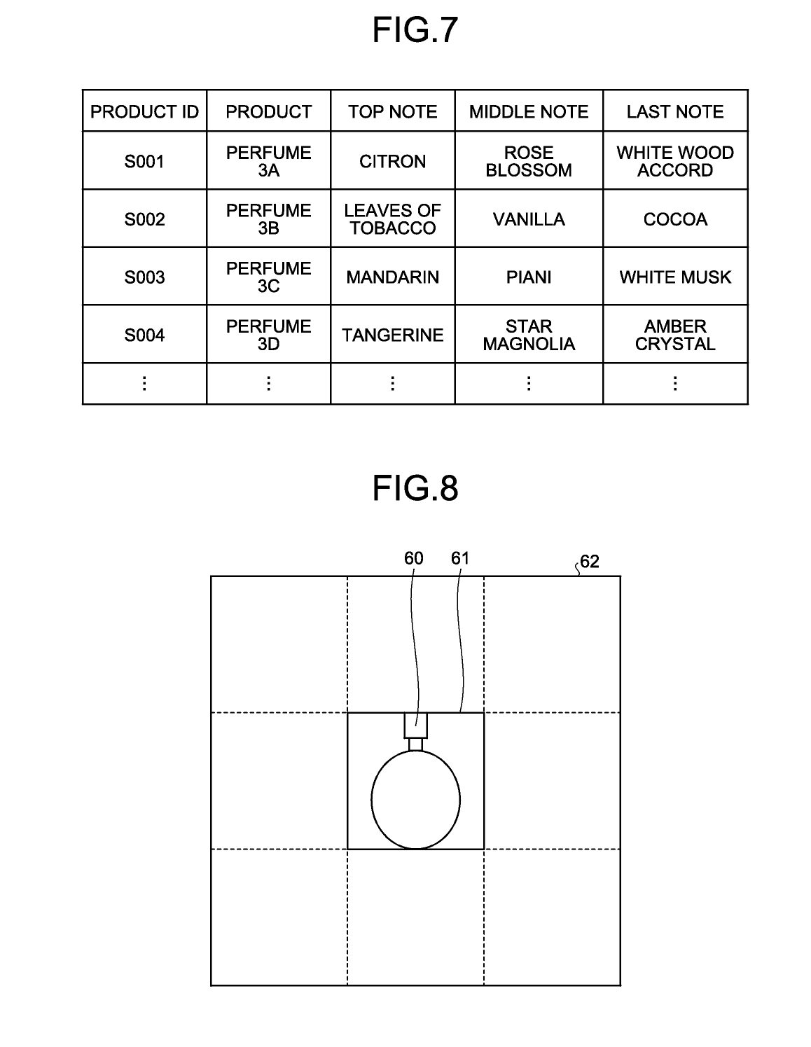

FIG. 7 is a schematic diagram illustrating an example of the data structure of product impression information. As illustrated in FIG. 7, the product impression information 42 includes items of the “product ID”, the “product”, the “top note”, the “middle note”, and the “last note”. The item of the product ID is an area that stores therein identification information for identifying the product. The item of the product is an area that stores therein information that indicates the product. Each of the items of the top note, the middle note, and the last note is an area that stores therein information related to an image representing each of the odors. Here, an aroma of a perfume changes over time immediately after the perfume is applied to the skin. The top note is an area that stores therein information indicating an image of an aroma at about 10 to 30 minutes after application. The middle note is an area that stores therein information indicating an image of an aroma at about 2 to 3 hours after application. The last note is an area that stores therein information indicating an image of an aroma at about 5 to 12 hours after application.

In the example illustrated in FIG. 7, the product ID “S001” indicates that the product is the “perfume 3A”, the top note is “citron”, the middle note is “rose blossom”, and the last note is “White Wood Accord”.

A description will be given here by referring back to FIG. 4. The content data 43 is data that stores therein content, such as a video image or an image used for the promotion of the products. For example, as the content data 43, data on the video image indicated by the display content information 41 is stored. For example, as the content data 43, data on the video image of advertisement of the perfumes 3A to 3D to be promoted is stored. Furthermore, as the content data 43, data on the images associated with the impression of the aroma of each of the items of the top note, the middle note, and the last note in the product impression information 42 is stored.

The Internet information 44 is data that stores therein information related to each of the products acquired from the Internet. For example, in the Internet information 44, information related to each of the products acquired from the SNS 25 is stored.

The control unit 33 is a device that controls the control device 20. As the control unit 33, an electronic circuit, such as a central processing unit (CPU), a micro processing unit (MPU), and the like, or an integrated circuit, such as an application specific integrated circuit (ASIC), a field programmable gate array (FPGA), and the like, may also be used. The control unit 33 includes an internal memory that stores therein control data and programs in which various kinds of procedures are prescribed, whereby the control device 20 executes various kinds of processes. The control unit 33 functions as various kinds of processing units by various kinds of programs being operated. For example, the control unit 33 includes a setting unit 50, an identifying unit 51, a detecting unit 52, an acquiring unit 53, and a display control unit 54.

The setting unit 50 performs various kinds of settings. For example, in accordance with the position of the product, the setting unit 50 sets an area for detecting a pickup of a product. For example, based on the characteristic of each of the products, the setting unit 50 detects the area of each of the products from the captured image that is input from the sensor device 21. For example, the setting unit 50 detects, based on the characteristic, such as the color or the shape of each of the perfumes 3A to 3D, the area of each of the perfumes 3A to 3D from the captured image. Then, the setting unit 50 sets, for each product, a first area associated with the position of the product. For example, the setting unit 50 sets, as the first area for each product, the rectangular shaped area enclosing the product area. The first area is an area for determining whether a customer has touched the product. Furthermore, the setting unit 50 sets, for each product, a second area that includes the first area. For example, the setting unit 50 sets, for each product, the second areas each having the same size such that each of the second areas are arranged around the first area. The second area is an area for determining whether a customer has picked up the product.

FIG. 8 is a schematic diagram illustrating an example of an area. For example, the setting unit 50 detects, based on the characteristic, such as the color or the shape of the perfume 3A, an area 60 of the perfume 3A from the captured image. Furthermore, the setting unit 50 sets the rectangular shaped area enclosing the area of the perfume 3A to a first area 61. Furthermore, the setting unit 50 sets a second area 62 in which, for example, each of the size areas having the same size as that of the first area 61 is arranged around the first area 61.

The identifying unit 51 performs various kinds of identification. For example, the identifying unit 51 identifies the attribute of a person detected by the sensor device 21. For example, the identifying unit 51 identifies, as the attribute of the person, the gender and the age group of the detected person. In the embodiment, the age group is identified in two stages, i.e., young people and mature age. For example, the standard pattern of the contour of a face or the positions of the eyes, the nose, the mouth, or the like is stored in the storage unit 32 for each gender and age group. Then, if a person is detected by the sensor device 21, the identifying unit 51 detects a face area from the image that is input from the sensor device 21. Then, by comparing the contour of the face and the positions of the eyes, the nose, and the mouth of the detected face area with the standard pattern for each gender and age group and by specifying the most similar pattern, the identifying unit 51 identifies the gender and the age group. Furthermore, identification of the attribute of the person may also be performed by the sensor device 21. Namely, the sensor device 21 may also perform the identification of the attribute of the person and output the attribute information on the identification result to the control device 20.

The detecting unit 52 performs various kinds of detection. For example, the detecting unit 52 detects, for each product, whether a product has been picked up. For example, the detecting unit 52 monitors, in the captured image that is input from the sensor device 21, the first area of each of the products that are set by the setting unit 50 and detects whether a human hand enters in the first area. For example, if the coordinates of a fingertip of a human hand that is input from the sensor device 21 is within the first area, the detecting unit 52 detects that the human hand has entered in the first area.

After the detecting unit 52 detects the human hand in the first area, if the human hand is not detected in the second area any more, the detecting unit 52 determines whether the product is detected in the product area. If the product is not detected in the product area, the detecting unit 52 detects that the product has been picked up. For example, if it is detected that the human hand enters in the first area that is set for the perfume 3A and then the state becomes the human hand is not detected in the second area that is set for the perfume 3A and, furthermore, the perfume 3A is not detected, the detecting unit 52 detects that the perfume 3A has been picked up. Furthermore, the number of products targeted for the detection obtained by the detecting unit 52 may also be one or more.

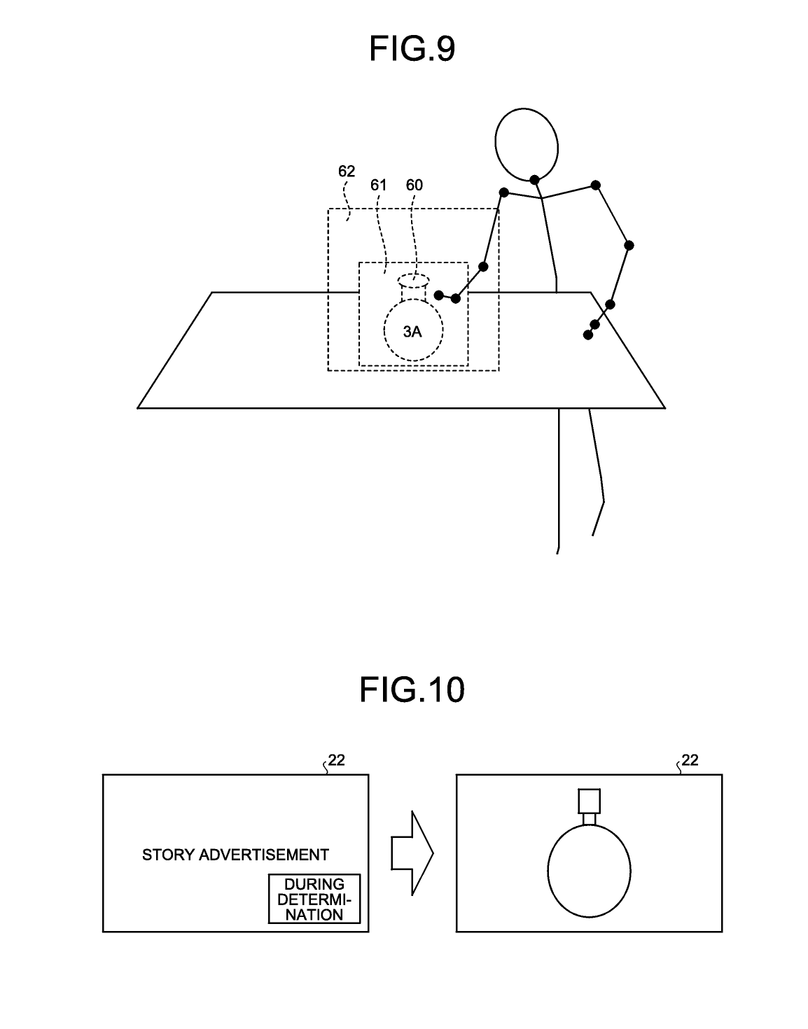

FIG. 9 is a schematic diagram illustrating detection of a pickup. For example, the detecting unit 52 monitors the first area 61 of the perfume 3A and detects whether a human hand enters in the first area 61. In the example illustrated in FIG. 8, the human hand enters in the first area 61. If the human hand is not detected any more in the second area 62 in which the human hand was detected and if the product is not detected in the area 60 of the perfume 3A, the detecting unit 52 detects that the perfume 3A has been picked up. Consequently, it is possible to distinguish the case in which the product is just touched from the case in which the produce has been picked up.

The acquiring unit 53 performs various kinds of acquisition. For example, the acquiring unit 53 acquires information related to each of the products from the Internet. For example, the acquiring unit 53 searches the SNS 25 for the posting related to each of the products and acquires information related to each of the products. Furthermore, the acquiring unit 53 may also acquire information related to each of the products by accepting, from the SNS 25, the posting related to each of the products. For example, the SNS 25 may also periodically provide the posting related to each of the products to the control device 20 and the acquiring unit 53 may also acquire information related to each of the provided products.

The acquiring unit 53 stores the posting related to each of the acquired products in the Internet information 44.

The display control unit 54 controls various kinds of displays. For example, if no person is detected by the sensor device 21, the display control unit 54 displays, on the display 22, product information in accordance with a predetermined scenario. For example, the display control unit 54 repeatedly displays, on the display 22, video images of the content of each of the products in a predetermined order. Furthermore, another video image that is other than the video image of the content of each of the products may also be displayed. For example, in addition to the video image of the content of each of the products, data on a video image of product information for an advertisement that is in accordance with the predetermined scenario is previously stored in the storage unit 32 and, if no person is detected by the sensor device 21, the display control unit 54 may also repeatedly display, on the display 22, the data on the subject video image.

If a person is detected by the sensor device 21, the display control unit 54 specifies the product that is associated with the attribute of the person detected by the identifying unit 51. For example, if the attribute of the person is identified as the category of “young people” and “women”, the display control unit 54 specifies the perfume 3A that is associated with the “young people” and the “women” is the associated product. The display control unit 54 displays, on the display 22, the information related to the specified product. For example, based on the display content information 41, the display control unit 54 reads, from the content data 43, the data on the content associated with the specified perfume 3A and displays, on the display 22, the video image of the read content.

After the display control unit 54 displays the video image of the content on the display 22, the display control unit 54 determines whether a predetermined behavior of the person is detected by the sensor device 21. The predetermined behavior mentioned here is the behavior that indicates whether a person has expressed an interest. For example, if the person is interested in the video image displayed on the display 22, the person stops to see the video image. Thus, for example, if the detected person still stays after a predetermined time has elapsed since the video image has been displayed on the display 22, the display control unit 54 determines that the predetermined behavior has been detected. Furthermore, the predetermined behavior is not limited to the stay of the detected person for the predetermined time period and any behavior may also be used as long as the behavior indicates that a person has expressed an interest. For example, after the video image is displayed on the display 22, if a person is detected, it may also be possible to be determined that the predetermined behavior is detected. Furthermore, for example, if a line of sight of a detected person is detected and if the line of sight of the person is pointed, for the predetermined time or more, to the display 22 or to the product that is associated with the video image displayed on the display 22, it may also be possible to be determined that the predetermined behavior is detected.

If the predetermined behavior of the person is detected, the display control unit 54 starts to display, on the tablet terminal 23, the information related to the product. For example, the display control unit 54 reads, from the Internet information 44, the information that is related to the specific product and that is acquired from the Internet and then displays the read information on the tablet terminal 23.

Furthermore, if the predetermined behavior of the person is detected, the display control unit 54 ends the display of the video image of the content of the display 22. After the end of the display of the video image of the content on the display 22, similarly to the case in which no person is detected, the display control unit 54 displays, on the display 22, the product information that is in accordance with the predetermined scenario. For example, the display control unit 54 repeatedly displays, on the display 22, the video image of the content of each of the products in a predetermined order.

If the detecting unit 52 detects that a product has been picked up, the display control unit 54 outputs the video image associated with the picked up product. For example, the display control unit 54 reads the data on the content associated with the picked up product and projects the video image of the read content from the projector 24. Consequently, for example, if the perfume 3A has been picked up, a video image is projected in the direction of the perfume 5A that is the same type of the perfume 3A and that is arranged on the display stand 4. The display control unit 54 changes, in accordance with the product impression information 42, the video image that is projected from the projector 24 and then represents the temporal change of the odor emitted from the perfume 3A by using the video image. For example, the display control unit 54 sequentially projects, at a predetermined timing, each of the images of the top note, the middle note, and the last note and represents the temporal change of the odors by using the video image. At this time, the display control unit 54 may also project the images by adding various kinds of image effects. For example, the display control unit 54 displays an image by changing the effect every two seconds or the like. Consequently, the person who picked up the perfume 3A can perceive, in a pseudo manner from the video image projected in the direction of the perfume 5A, the temporal change of the odor emitted from the perfume 3A. Furthermore, the display control unit 54 may also project a video image that indicates the characteristic of the product or the effect of the product. Furthermore, the display control unit 54 may also change, for each attribute of a person, the type of the video image to be projected. For example, if the attribute is a woman, the display control unit 54 may also project the video image representing the odor emitted from the perfume 3 and, if the attribute is a man, the display control unit 54 may also project the video image representing, for example, the characteristic or the effect of the perfume 3.

If the detecting unit 52 detects that another product is picked up when the video image is being projected, the display control unit 54 outputs the video image associated with the subject picked up product. For example, if a pickup of the perfume 3A is detected and then if a pickup of the perfume 3B is detected when the video image is being projected in the direction of the perfume 5A, the display control unit 54 stops to project the video image output in the direction of the perfume 5A. Then, the display control unit 54 reads the data on the content associated with the picked up perfume 3B and projects the video image of the read content from the projector 24. Consequently, projection of the video image in the direction of the perfume 5A is stopped and the video image is projected in the direction of the perfume 5B that is arranged on the display stand 4.

Here, a description will be given by using a specific example. FIG. 10 is a schematic diagram illustrating an example of an image displayed on the display. If no person is detected by the sensor device 21, the display control unit 54 displays, on the display 22, the product information that is in accordance with the predetermined scenario. The display control unit 54 repeatedly displays, on the display 22, the video image of the content of each of the products in the predetermined order. The screen example on the left side illustrated in FIG. 10 indicates that a story advertisement in accordance with the predetermined scenario is displayed.

If a person is detected by the sensor device 21, the identifying unit 51 identifies the attribute of the person detected by the sensor device 21. The display control unit 54 displays, on the display 22, the video image of the content of the product associated with the identified attribute of the person. The screen example on the right side illustrated in FIG. 10 indicates that, if a person is detected, the video image of the perfume associated with the attribute of the detected person is displayed. Consequently, because the advertisement of the product associated with the attribute of the person is displayed toward the detected person, it is possible to implement the sales promotion in which preferences of each customer is determined and it is possible to increase the effect of advertisements. Furthermore, in the example illustrated in FIG. 10, a message of being determined is displayed on the story advertisement when the display control unit 54 is performing identification of the attribute of the person; however, the display of being determined does not need to be displayed.

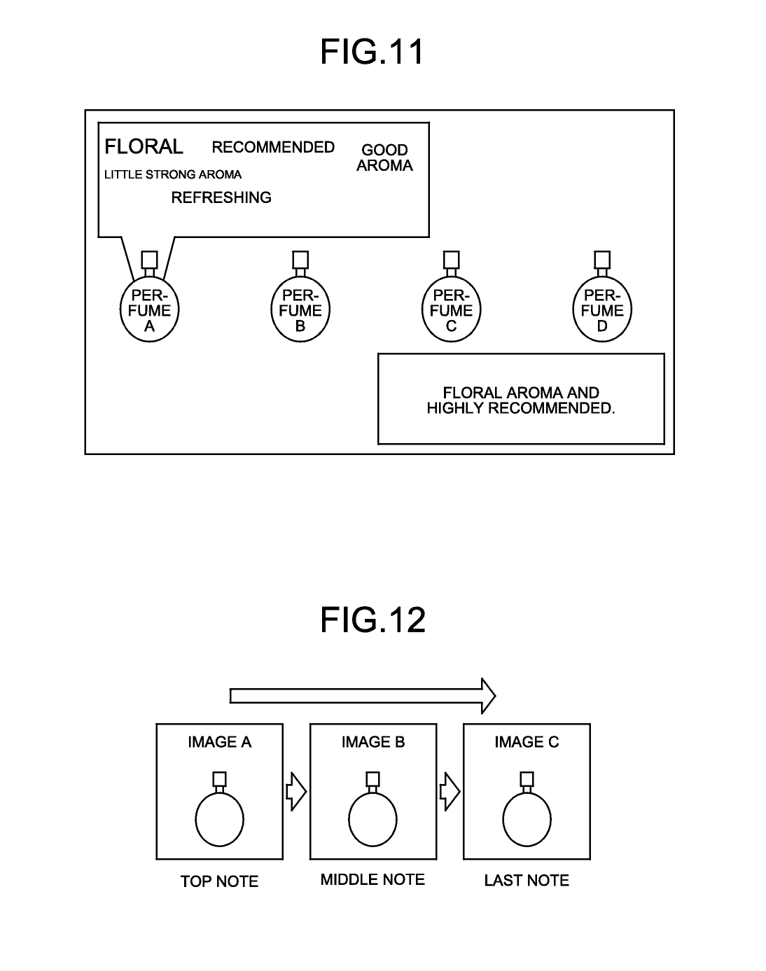

After having displayed the video image of the content on the display 22, if the predetermined behavior of a person is detected, the display control unit 54 allows the tablet terminal 23 to start to display the information related to the product. For example, the display control unit 54 reads, from the Internet information 44, the information acquired from the Internet related to the product associated with the attribute of the person and displays the read information on the tablet terminal 23. FIG. 11 is a schematic diagram illustrating an example of an image displayed on the tablet terminal. In the example illustrated in FIG. 11, regarding the keywords often included in an article that is related to the product and that is posted to the SNS 25 are displayed, the characters are displayed in a larger size as the characters appear more frequently. Furthermore, in the example illustrated in FIG. 11, the article related to the product posted to the SNS 25 is displayed. Consequently, evaluations from a third party related to the product can be submitted to the detected person. Here, in recent years, the evaluation of a third party, such as word-of-mouth, sometimes greatly give effect to a purchase behavior. For example, if a person purchases a product, the person sometimes searches, for example, the SNS 25 for the evaluation from a third party in order to determine whether the person purchases the product. Thus, by submitting the evaluation of a third party related to the product to the tablet terminal 23, it is possible to provide a sense of security or reliability with respect to the product rather than simply providing the advertisement related to the product.

If a product has been picked up, the display control unit 54 projects a video image in the direction of a physically different product with the same type of the picked up product. In the embodiment, in the direction of the perfume 5 that is the same type of the picked up perfume 3 and that is separately arranged, the images, i.e., the top note, the middle note, and the last note, are sequentially projected and the temporal change of the odor is represented by the video image. FIG. 12 is a schematic diagram illustrating an example of images projected. In the example illustrated in FIG. 12, the images are sequentially changed from the image A that represents the top note aroma to the image B that represents the middle note aroma and the image C that represents the last note aroma. Consequently, by projecting the video image in the direction of the perfume 5 associated with the picked up perfume 3, it is possible to perceive, in a pseudo manner from the projected video image, the temporal change of the odor emitted from the picked up perfume 3. Furthermore, by causing the odors from the projected video images to perceive in a pseudo manner, it is possible to improve the impression of the product.

In this way, the product information display system 10 can more effectively perform the promotion of the products with respect to a customer.

Furthermore, the control device 20 may also further display incentive information related to the product. For example, the display control unit 54 may also display, on the tablet terminal 23 by using a two-dimensional barcode or the like, a coupon for a discount of the picked up product. Consequently, the product information display system 10 can urge a person to purchase the product.

Furthermore, the control device 20 may also accumulate a response status of a person. For example, the control device 20 accumulates, for each product, the number of times the attribute of a target person is detected, a predetermined behavior, and the number of times a pickup is detected, whereby it is possible for a customer targeted for the product to evaluate justification or the effect of the displayed video image and review the content of the promotion.

Flow of a Process

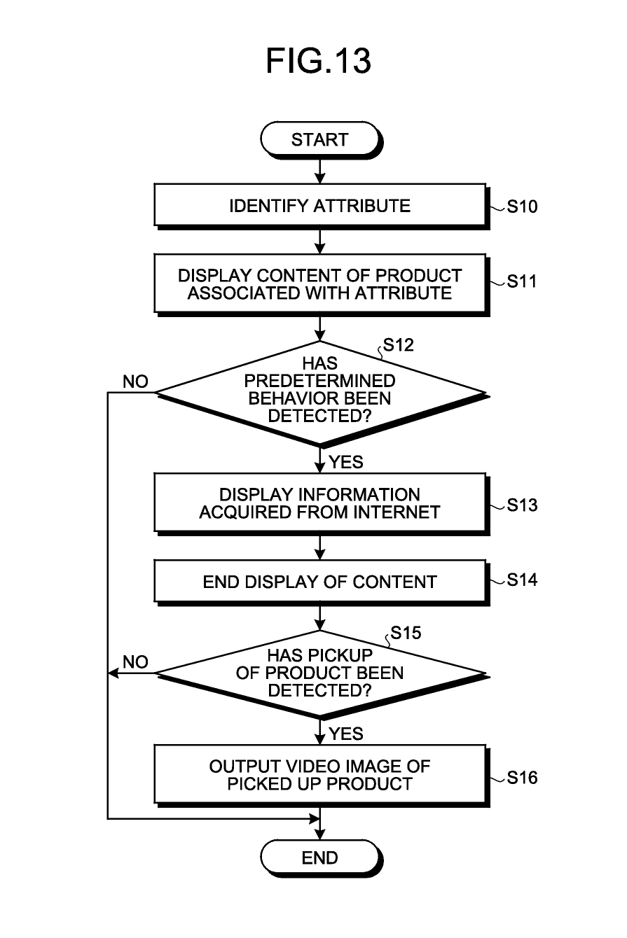

The flow of the display control performed by the control device 20 according to the embodiment will be described. FIG. 13 is a flowchart illustrating an example of the flow of a display control process. The display control process is performed at a predetermined timing, for example, at a timing at which a person is detected by the sensor device 21.

If no person is detected by the sensor device 21, the display control unit 54 repeatedly displays, on the display 22, the video image of the content of each of the products in the predetermined order.

If a person is detected by the sensor device 21, as illustrated in, the identifying unit 51 identifies the attribute of the person detected by the sensor device 21 (Step S10). The display control unit 54 displays, on the display 22, the video image of the content of the product that is associated with the identified attribute of the person (Step S11).

The display control unit 54 determines whether the predetermined behavior of the person is detected (Step S12). If the predetermined behavior is not detected (No at Step S12), the process is ended.

In contrast, if the predetermined behavior is detected (Yes at Step S12), the display control unit 54 reads, from the Internet information 44, the information that is related to the product associated with the attribute of the person and that is acquired from the Internet and then displays the read information on the tablet terminal 23 (Step S13). Furthermore, the display control unit 54 ends the display of the video image of the content on the display 22 (Step S14).

The display control unit 54 determines whether a pickup of the product is detected by the detecting unit 52 (Step S15). If the pickup of the product is not detected (No at Step S15), the process is ended.

In contrast, if the pickup of the product is detected (Yes at Step S15), the display control unit 54 outputs the video image associated with the picked up product from the projector 24 (Step S16). When the display control unit 54 ends the output of the video image, the process is ended.

When the display control unit 54 ends the display control process, the display control unit 54 repeatedly displays the video image of the content of each of the products on the display 22 in the predetermined order. Furthermore, the process at Step S14, after the display of the video image of the content of the product on the display 22 is ended, it may also be possible to start the display of the story advertisement in accordance with the predetermined scenario.

Effect

As described above, in the product information display system 10 according to the embodiment, the control device 20 controls the start of display, on the display 22, of first information related to a specific product determined in accordance with the attribute of a person detected by the sensor device 21. Furthermore, after the start of the display, on the display 22, of the first information, if it is detected that a behavior of the detected person indicates a predetermined behavior, the control device 20 controls the start of display, on the tablet terminal 23, of second information related to the specific product. Consequently, the product information display system 10 can maintain the interest of the person with respect to the product.

Furthermore, if the detected person still stays after a predetermined time has elapsed since the display of the first information on the display 22 or after the first information has been displayed in accordance with a predetermined display scenario, the product information display system 10 determines this state is the predetermined behavior. Consequently, the product information display system 10 can detect the behavior representing the interest of the person and can start to display the second information on the tablet terminal 23.

Furthermore, when the display of the second information is started, the product information display system 10 ends the display, on the display 22, of the first information. In this way, by ending the display, on the display 22, of the first information, the product information display system 10 can make person's attention focus on the tablet terminal 23.

Furthermore, in the product information display system 10, the size of the tablet terminal 23 is smaller than that of the display 22. Consequently, in the product information display system 10, the tablet terminal 23 can be arranged close to the products.

Furthermore, in the product information display system 10, the tablet terminal 23 is arranged on the product shelf on which specific products are exhibited. Consequently, the product information display system 10 can display the information associated with the specific product by the tablet terminal 23.

Furthermore, the product information display system 10 outputs, from the display 22, product information that includes therein not only the specific products but also the information related to the other products. Consequently, the product information display system 10 can advertise not only the specific products but also various kinds of products.

Furthermore, the product information display system 10 displays, on the tablet terminal 23, the information on the specific products acquired from the Internet. Consequently, by simply providing advertisement related to the products, the product information display system 10 can provide a sense of security or reliability with respect to the products.

### [b] Second Embodiment

In the above explanation, a description has been given of the embodiment of the device disclosed in the present invention; however, the present invention can be implemented with various kinds of embodiments other than the embodiment described above. Therefore, another embodiment included in the present invention will be described below.

For example, in the embodiment described above, a case of outputting a video image expressing the odor of each of the products has been described; however, the disclosed device is not limited to this. For example, the control device 20 may also output a video image representing the taste, the texture, the sound emitted, or the like of each of the products. The taste can be expressed by a video image of a food material representing the type of tastes, such as sweetness, sourness, saltiness, bitterness, pungency, astringency, or the like. For example, the degree of fruity, such as sweetness or the like, can be visualized by expressed by the type and an amount (the number) of other fruits other than the product and it is possible to improve ease of imaging due to visual effect. The texture can also be expressed by a video image of goods each representing the type of texture. For example, a rough touch as the texture can be expressed by, for example, the roughness of the surface of the goods. Furthermore, for example, freshness as the texture can be expressed by, for example, shaking of the surface of the water or a sense of speed, stickiness, an amount of moisture, or the way of repellent at the time of a drop of a water droplet. The sound can be expressed as a waveform by, for example, effecting the sound. Furthermore, a plurality of combinations of the odor, the taste, the texture, and the sound emitted of the product may also be expressed by a video image.

Furthermore, in the embodiment described above, a case of using the products as the perfumes has been described; however, the disclosed device is not limited to this. Any products may also be used as long as the products have different odors, tastes, textures, sounds emitted, or the like. For example, if wine is used as the product, it is conceivable that the odor, the taste, and the texture are expressed by a video image. Furthermore, if cosmetics, such as emulsion, are used as the products, it is conceivable that the texture is expressed by a video image. Furthermore, if cars or motorcycles are used as the products, it is conceivable that the sound emitted is expressed by a video image. In this way, by expressing the odor, the taste, the texture, and the sound emitted of the products by a video image, it is possible to encourage customers to buy.

Furthermore, in the embodiment described above, a case of arranging the single tablet terminal 23 has been described; however, the disclosed device is not limited to this. A plurality number of the tablet terminals 23 may also be arranged. For example, if a plurality of the product shelfs 2 is present, the tablet terminal 23 may also be provided for each of the product shelfs 2. Furthermore, the tablet terminal 23 may also be provided each of one or a plurality of products. Furthermore, in the embodiment described above, a case of providing the single display 22 has also been described; however, the disclosed device is not limited to this. A plurality number of the displays 22 may also be provided.

Furthermore, in the embodiment described above, a case of providing the perfumes 5 with respect to the perfumes 3, respectively, has been described; however, the disclosed device is not limited to this. For example, the single perfume 5 is provided and a video image representing the odor of each of the perfumes 3 may also be projected in the direction of the perfume 5. Namely, if, for example, a specific behavior, such as a behavior of picking up one of the perfumes 3A to 3D, is detected, the video image representing the odor of the detected perfume may also be projected in the direction of the perfume 5A. In this case, the shape of the perfume 5 may also be the same as the shape of one of the perfumes 3 or may also be the shape of a typical perfume bottle.

Furthermore, in the embodiment described above, a case of ending, if the display of the second information is started on the tablet terminal 23, the display of the first information on the display 22 has been described; however, the disclosed device is not limited to this. For example, if the display, on the tablet terminal 23, of the second information is started, the display of the product information in accordance with a predetermined scenario may also be performed by the display 22.

Furthermore, in the embodiment described above, an example in which the display 22 and the tablet terminal 23 are different devices has been described; however, the disclosed device is not limited to this. The first display exemplified by the display 22 and the second display exemplified by the tablet terminal 23 may also be used as an output to the same display device. In this case, a first display area corresponding to the first display and a second display area corresponding to the second display can be provided on the same display device.

Furthermore, the components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, each of the processing units, i.e., the setting unit 50, the identifying unit 51, the detecting unit 52, the acquiring unit 53, and the display control unit 54, may also appropriately be integrated. Furthermore, the processes performed by the processing units may also appropriately be separated into processes performed by a plurality of processing units. Furthermore, the processes performed by the processing units may also appropriately be separated into processes performed a plurality of processing units. Furthermore, all or any part of the processing functions performed by each of the processing units can be implemented by a CPU and by programs analyzed and executed by the CPU or implemented as hardware by wired logic.

Control Program

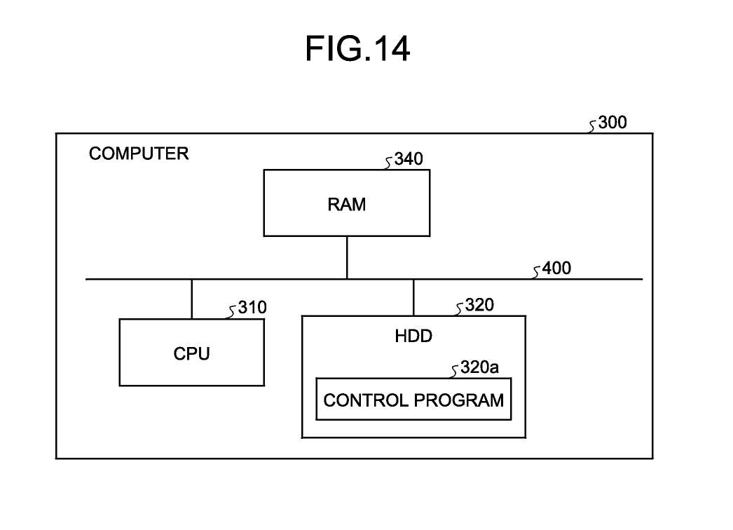

Furthermore, various kinds of processes described in the above embodiments can be implemented by executing programs prepared in advance for a computer system, such as a personal computer or a workstation. Accordingly, in the following, a description will be given of an example of a computer system that executes a program having the same function as that performed in the embodiments described above. FIG. 14 is a block diagram illustrating a computer that executes a control program.

As illustrated in FIG. 14, a computer 300 includes a central processing unit (CPU) 310, a hard disk drive (HDD) 320, and a random access memory (RAM) 340. These units 300 to 340 are connected by a bus 400.

The HDD 320 previously stores therein control programs 320a having the same function as that performed by the setting unit 50, the identifying unit 51, the detecting unit 52, the acquiring unit 53, and the display control unit 54 described above. Furthermore, the control programs 320a may also appropriately be separated.

Furthermore, the HDD 320 stores therein various kinds of information. For example, the HDD 320 stores therein data on various kinds of content, such as video images, images, or the like, that are used for the promotion of the products.

Then, the CPU 310 reads the control programs 320a from the HDD 320 and executes the control programs 320a, whereby the CPU 310 executes the same operation as that executed by each of the processing units according to the embodiments. Namely, the control programs 320a execute the same operation as those executed by the setting unit 50, the identifying unit 51, the detecting unit 52, the acquiring unit 53, and the display control unit 54.

Furthermore, the control programs 320a described above do not need to be stored in the HDD 320 from the beginning.

For example, the programs are stored in a “portable physical medium”, such as a flexible disk (FD), a CD-ROM, a DVD disk, a magneto-optic disk, an IC CARD, or the like, that is to be inserted into the computer 300. Then, the computer 300 may also read and execute these programs from the portable physical medium.

Furthermore, the programs may also be stored in “another computer (or a server)” connected to the computer 300 via a public circuit, the Internet, a LAN, a WAN, or the like. Then, the computer 300 may also read and execute the programs from the other computer.

According to an aspect of an embodiment of the present invention, it is possible to easily and continuously make a person interested in the products.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A product information display system comprising:
a sensor;
a first display;
a second display; and
a processor configured to:
perform a first start of displaying, on the first display, first information related to a specific product specified in accordance with an attribute of a person detected by the sensor; and
perform a second start of displaying, on the second display, second information related to the specific product when it is detected that a behavior of the detected person indicates a predetermined behavior after the first start of display.

2. The product information display system according to claim 1, wherein the predetermined behavior is a stay of the detected person after a predetermined time has elapsed since the start of the display, on the first display, of the first information or after the first information has been displayed in accordance with a predetermined display scenario.

3. The product information display system according to claim 1, wherein, when the display of the second information is started, the display, on the first display, of the first information is ended.

4. The product information display system according to claim 1, wherein, before the start of the display, on the first display, of the first information related to the specific product determined in accordance with the attribute of a person detected by the sensor, product information that is in accordance with a predetermined scenario is displayed on the first display and, when the display of the second information is started, the product information that is in accordance with the predetermined scenario is displayed on the first display.

5. The product information display system according to claim 1, wherein a size of the second display is smaller than a size of the first display.

6. The product information display system according to claim 1, wherein the second display is arranged on a product shelf on which the specific product is exhibited.

7. The product information display system according to claim 1, wherein the second display is arranged at the position closer to the specific product than the first display.

8. The product information display system according to claim 1, wherein the product information that is in accordance with the predetermined scenario includes information related to not only the specific product but also another product.

9. The product information display system according to claim 1, wherein the second information is created based on information that is related to the specific product and that is acquired from the Internet.

10. The product information display system according to claim 1, wherein the processor is configured to further control, after the start of the display on the second display, when it is detected that the person indicates a specific behavior with respect to a first product, the start of an output of a video image that is associated with the first product and that is output in the direction of a second product that is physically different from the first product.

11. A control device comprising:
a processor configured to:
perform a first start of displaying, on the first display, first information related to a specific product specified in accordance with an attribute of a person detected by a sensor; and
perform a second start of displaying, on the second display, second information related to the specific product when it is detected that a behavior of the detected person indicates a predetermined behavior after the first start of display.

12. A non-transitory computer-readable recording medium storing a control program that causes a computer to execute a process comprising:
performing a first start of displaying, on the first display, first information related to a specific product specified in accordance with an attribute of a person detected by a sensor; and
performing a second start of displaying, on the second display, second information related to the specific product when it is detected that a behavior of the detected person indicates a predetermined behavior after the first start of display.

13. A control method comprising:
performing a first start of displaying, on the first display, first information related to a specific product specified in accordance with an attribute of a person detected by a sensor; and
performing a second start of displaying, on the second display, second information related to the specific product when it is detected that a behavior of the detected person indicates a predetermined behavior after the first start of display.
